(19) United States
(12) Patent Application Publication
(10) Pub. No.: US 2005/0062997 A1
(43) Pub. Date: Mar. 24, 2005

(54) Image processing apparatus, and image processing method and program therefor

(75) Inventors: Reiji Hasegawa, Kanagawa (JP); Takeshi Suzuki, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/944,719

(22) Filed: Sep. 21, 2004

(30) Foreign Application Priority Data
Sep. 24, 2003 (JP) 2003-332508

(51) Int. Cl. G06F 3/12; G06F 3/00; G06F 13/00

(52) U.S. Cl. 358/1.13; 358/1.15; 710/19; 710/29; 710/52

(57) ABSTRACT

It is the objective of the present invention to provide an image forming apparatus that has a plurality of functions, such as a printer function, a scanner function and a facsimile communication function, wherein first bus connection means is compatible with HighSpeed USB and second bus connection means is compatible with FullSpeed USB, and wherein HighSpeed USB communication can be performed with a data processing terminal, such as a personal computer. The image processing apparatus includes two bus connection means having different communication speeds. One of the bus connection means is first bus connection means, connected to the main controller, and the other bus connection means is second bus connection means, for connecting the main controller and a plurality of data processing portions to perform bi-directional communication.

### BACKGROUND OF THE INVENTION

1. Field of the Invention

The present invention relates to an image processing apparatus, and an image processing method and a program therefor.

2. Related Background Art

Of the image processing apparatuses that can be connected to a data processing apparatus, such as a personal computer, an image processing apparatus is well known that includes a USB function controller, which is connected to an external processing apparatus, and a USB host controller, which is connected to a recording unit, etc. in the interior of a compound apparatus, for the easy actualization of concurrent operations of a plurality of functions, such as a printer function, a scanner function and a facsimile communication function (see, for example, patent document 1, Japanese Patent Application Laid-Open No. 2003-198779).

A detailed explanation will now be given for the schematic configuration of an image processing apparatus 900 that employs a conventional image processing system.

FIG. 9 is a schematic block diagram showing the configuration of a conventional image processing apparatus 900.

In the image processing apparatus 900, a CPU 901 is a system controller that provides control for the entire image processing apparatus 900. A ROM 902 is used to store control programs, executed by the CPU 901, and fixed data, such as a data table and an incorporated operating system (OS). The individual control programs stored in the ROM 902 execute software processes, such as a scheduling process or a task switching process, under the control of the incorporated OS stored in the ROM 902.

A RAM 903 is constituted, for example, by a static random access memory (SRAM) and stores program control variables and others. Furthermore, setup values registered by an operator and management data for the image processing apparatus 900 are stored in the RAM 903, and various work buffer areas are provided therein. An image memory 904, used to store image data, is constituted by a dynamic random access memory (DRAM) and others.

A data converter 905 analyzes a page description language (PDL) or converts image data, such as those for computer Graphics (CG), developed for character data.

A read controller 906 provides control for a reading unit 907, which permits a CIS image sensor (a contact type image sensor) to optically read a document, converts an image signal to electrical image data, and causes an image processing controller (not shown) to perform various image processes, such as a binary process and a half tone process, for the electrical image data, and thus outputs high definition image data.

In this example, the read controller 906 and the reading unit 907 are compatible with both (1) a sheet reading control method, whereby a fixed CIS image sensor reads a document that is being conveyed, and (2) a book reading control method, whereby a moving CIS image sensor scans a document placed on a document table.

An operation/display unit 908 includes: (1) an operating unit, which has numerical value input keys, character input keys, a one-touch dial key, a mode setup key, an entry (or decision) key, a cancel key etc., and which a user employs to select data for an image transmission destination and to register setup data; and (2) a display unit, which has various keys, a light emitting diode (LED), a liquid crystal display unit (LCD), etc. and on which a variety of operations entered by an operator, the operating state and status conditions of the image processing apparatus 900, are displayed.

A communication controller 909 is constituted, for example, by a modulator-demodulator (MODEM) and a network control unit (NCU). In the above conventional example, the communication controller 909 is connected to an analog communication line (PSTN) 931, and provides communication control, in accordance with T.30 protocol, and network control for sending and accepting calls via a communication line.

A resolution converter 910 performs resolution conversion, such as the mutual conversion of image data expressed using millimeters and image data expressed using inches. The resolution converter 901 can also enlarge or reduce the size of image data.

A codec 911 performs mutual encoding or decoding of image data (uncompressed, or MH, MR, MMR, JPIB or JPEG format data) processed by the image processing apparatus 900, and performs an enlargement/reduction process for the obtained data.

A record controller 912 causes an image processing controller (not shown) to execute various image processes, such as a smoothing process, a recording density correction process and a color correction process, for image data to be printed, and obtains and outputs high definition image data to a USB host controller 914, which will be described later. Further, the record controller 912 permits the USB host controller 914 to periodically obtain the status data for a recording unit 915.

A USB function controller 913 controls communication via a USB interface. In accordance with the USB communication standards, the USB function controller 913 provides protocol control, converting data obtained through the USB control task executed by the CPU 901, into USB packets to transmit to an external data processing terminal, and also converting USB packets received from the external data processing terminal, into data to transmit to the CPU 901.

The USB host controller 914 is a controller for performing communication in accordance with protocol defined by the USB communication standards. The USB communication standards enable fast bi-directional data communication, and a plurality of hubs or functions (slaves) can be connected to a single host (master). The USB host controller 914 functions as a host for USB communication.

The recording unit 915 is a recording apparatus, constituted, for example, by a laser beam printer or an ink jet printer, that prints color image data or monochrome image data on a printing material. In accordance with protocol conforming to the USB communication standards, the recording unit 915 also communicates with the USB host controller 914, in which case the recording unit 915 especially serves as a slave and a one-to-one USB connection is employed for communication with the recording unit 915.

The components 901 to 906 and 908 to 914 are interconnected via a CPU bus 921 controlled by the CPU 901.

In the conventional image processing apparatus 900, in order to directly transfer data between the recording unit 915 and a data processing apparatus, such as a personal computer, via the communication controller 909 and the USB host controller 914, the transfer speed for the USB function controller 913 must be the same as the transfer speed for the USB host controller 914.

An LSI chip used for HighSpeed USB (USB 2.0) is more expensive than that used for conventional FullSpeed USB. Thus, since manufacturing costs will be increased if HighSpeed USB is employed for both the USB function controller 913 and the USB host controller 914, the conventional image processing apparatus 900 should have been compatible only with FullSpeed USB.

Recently, however, data processing terminals, such as personal computers, have been developed that are compatible with HighSpeed USB having a maximum transfer speed of 480 Mbps. Therefore, when USB is employed for the exchange of a large amount of data by an image processing apparatus compatible with FullSpeed USB and a data processing terminal such as a personal computer, the FullSpeed USB 12 Mbps maximum transfer speed becomes a bottleneck, and an. extended period of time is required for the transfer of data. Therefore, it is difficult to use an image processing apparatus that is compatible with HighSpeed USB.

### SUMMARY OF THE INVENTION

It is one objective of the present invention to provide an image, processing apparatus that has a plurality of functions, such as a printer function, a scanner function and a facsimile communication function, wherein first bus connection means is compatible with HighSpeed USB and second bus connection means is compatible with FullSpeed USB, so that HighSpeed USB communication can be performed with a data processing terminal, such as a personal computer.

### BRIEF DESCRIPTION OF THE DRAWINGS

FIG. 1 is a schematic block diagram showing the configuration of an image processing apparatus according to one embodiment of the present invention;

FIG. 2 is a schematic block diagram showing the configuration of an external processing apparatus, such as a data processing terminal, which together with the image processing apparatus of the embodiment, constitutes an image processing system;

FIG. 3 is a conceptual diagram showing a configuration that conforms to the USB communication standards for the image processing apparatus of the embodiment;

FIG. 4 is a conceptual diagram showing the configuration that conforms to the USB communication standards for a recording unit according to the embodiment;

FIG. 5 is a flowchart showing the printing start operation, for the image processing apparatus, that is performed by the CPU according to the embodiment;

FIG. 6 is a flowchart showing the printing operation performed by the CPU of the image processing apparatus in a print mode at step S504 in FIG. 5;

FIG. 7 is a flowchart showing the print data transfer operation at step S602 in FIG. 6;

FIG. 8 is a flowchart showing the print state notification operation at step S604 in FIG. 6;

FIG. 9 is a schematic block diagram showing the configuration of a conventional image processing apparatus; and

FIG. 10 is a flowchart showing the suspension resuming operation at step S607 in FIG. 6.

### DETAILED DESCRIPTION OF THE PREFERRED EMBODIMENT

The best mode for carrying out the present invention is the following embodiment.

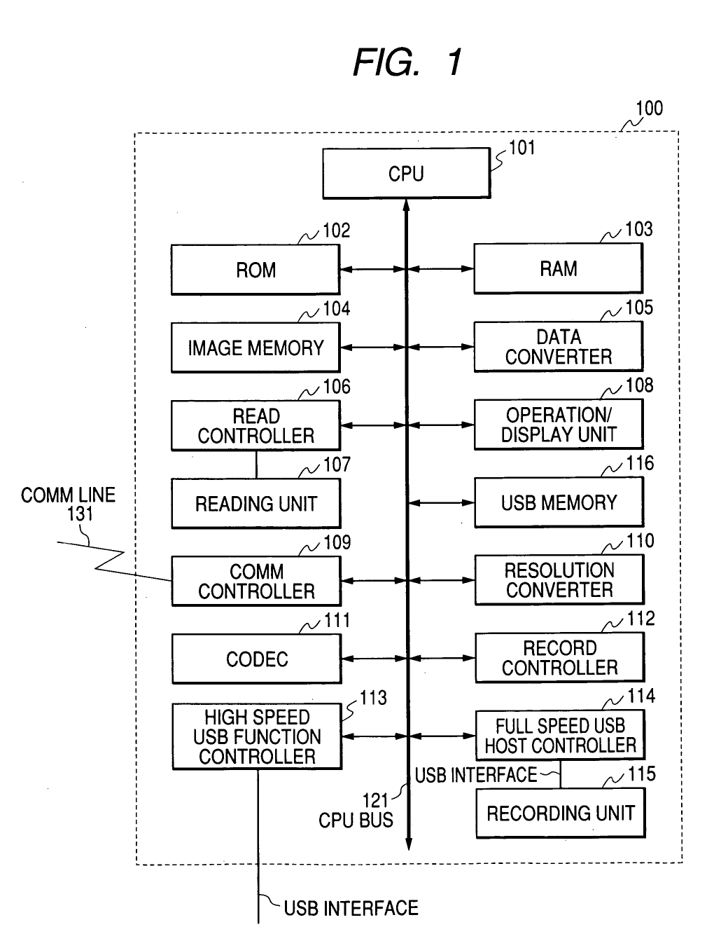

FIG. 1 is a schematic block diagram showing the configuration of an image processing apparatus 100 according to the embodiment of the present invention.

The image processing apparatus 100 comprises: a CPU 101, a ROM 102, a RAM 103, an image memory 104, a data converter 105, a read controller 106, a reading unit 107, an operation/display unit 108, a communication controller 109, a resolution converter 110, a codec 111, a record controller 112, a HighSpeed USB function controller 113, a FullSpeed USB host controller 114, a recording unit 115, a USB memory 116, and a CPU bus 121.

The CPU 101 is a system controller for controlling the entire image processing apparatus 100. The ROM 102 is used to store control programs executed by the CPU 101, and fixed data, such as a data table and an incorporated operating system (OS). In this embodiment, the control programs stored in the ROM 102 execute software processes, such as a scheduling process, a task switching process and an interrupt process, under the control of the incorporated OS stored in the ROM 102.

The RAM 103 is constituted, for example, by a static random access memory (SRAM), in which data can be held by a primary data backup battery (not shown). As an example, a program control variable, the data for which should not be deleted, are stored in the RAM 103. A memory area is also provided in the RAM 103 for the storage of setup values designated by an operator, and for management data for the image processing apparatus 100.

The image memory 104 is constituted by a dynamic random access memory (DRAM), and is used to store image data. Another part of the image memory 104 is reserved as a work area for performing a software process.

The data converter 105 analyzes a page description language (PDL), and performs image data conversion, such as a computer graphics (CG) development process for character data.

The read controller 106 controls the reading unit 107, which permits a CIS image sensor (a contact type image sensor) to optically read a document, converts image signal to electrical image data, and causes an image processing controller (not shown) to perform various image processes, such as a binary process and a half tone process, for the electrical image data, and thus outputs high definition image data.

In this embodiment, the read controller 106 and the reading unit 107 can cope with both (1) a sheet reading control method, whereby a fixed CIS image sensor reads a document that is being conveyed, and (2) a book reading control method, whereby a moving CIS image sensor scans a document placed on a document table.

The operation/display unit 108 includes: (1) an operating unit, which includes numerical value input keys, character input keys, a one-touch dial key, a mode setup key, an entry (or decision) key, a cancel key, etc., and which a user employs to select data for an image transmission destination and to register setup data; and (2) a display unit, which has various keys, a light emitting diode (LED) and a liquid crystal display unit (LCD) etc. and on which various operations entered by an operator, the operating state and status conditions of the image processing apparatus 100, are displayed.

The communication controller 109 is constituted by a modulator-demodulator (MODEM) and a network control unit (NCU). In the embodiment, the communication controller 109 is connected to an analog communication line (PSTN) and performs communication control, in accordance with T.30 protocol, and line control for sending and receiving calls via the communication line.

The resolution converter 110 performs resolution conversion, such as the mutual conversion of image data expressed using millimeters and image data expressed using inches. The resolution converter 110 can also perform an enlargement/reduction process for image data.

The codec 111 performs mutual encoding or decoding for image data (uncompressed, MH, MR, MMR, JBIG or MPEG format data) processed by the image processing apparatus 100, and performs an enlargement/reduction process for the obtained data.

The record controller 112 permits the image processing controller (not shown) to perform various image processes, such as a smoothing process, a recording density correction process and a color correction process, for image data to be printed, and obtains high definition image data that is output to the FullSpeed USB host controller 114. The record controller 112 also controls the FullSpeed USB host controller 114 that periodically obtains status data for the recording unit 115.

The HighSpeed USB function controller 113 controls communication of the USB interface. In accordance with the USB communication standards, the HighSpeed USB function controller 113 performs protocol control, converts into USB packets data obtained by the USB function control task executed by the CPU 101, and transmits the USB packets to an external data processing terminal (not shown). Further, the HighSpeed USB function converts into data USB packets received from the external data processing terminal, and transmits the data to the CPU 101.

The FullSpeed USB host controller 114 is a controller for performing communication according to protocol conforming to the USB communication standards. The USB communication standards enables fast bi-directional data communication, and by employing these standards, a plurality of hubs or functions (slaves) can be connected to a single host (master). The FullSpeed USB host controller 114 serves as a host for USB communication.

The recording unit 115 is a recording apparatus, such as a laser beam printer or an ink jet printer, controlled by a special CPU (not shown), and prints on a printing material color image data or monochrome image data received via a USB interface. According to protocol conforming to USB communication standards, the recording unit 115 performs communication with the FullSpeed USB host controller 114, and in this case, the recording unit 115 functions especially as a slave. In this embodiment, a one-to-one connection is employed by the recording unit 115 for USB communication, and further, the recording unit 115 is compatible with FullSpeed USB.

The USB memory 116 is constituted, for example, by DRAM, and absorbs a difference between the communication speed of the HighSpeed USB function controller 113 and the communication speed of the FullSpeed USB host controller 114. Print data to be transmitted to the recording unit 115 and status information obtained by the recording unit 115 are stored in the USB memory 116. Further, data to be written to a memory card (not shown) and data read from the memory card are also temporarily stored in the USB memory 116.

The components 101 to 106, 108 to 114 and 116 are interconnected by a CPU bus 121 managed by the CPU 101.

An explanation will now be given for the schematic configuration of an external processing apparatus 200, such as a data processing terminal, which, together with the image processing apparatus 100, constitutes the image processing system.

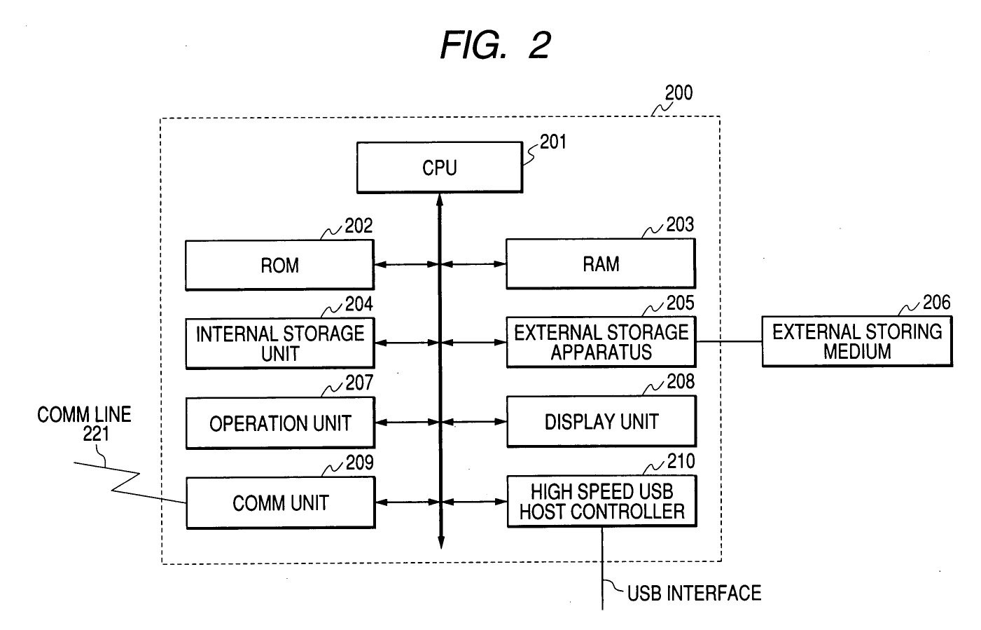

FIG. 2 is a schematic block diagram showing the configuration of the external processing apparatus 200, such as a data processing terminal, that together with the image processing apparatus 100, constitutes the image processing system.

The external processing apparatus 200 comprises: a CPU 201, a ROM 202, a RAM 203, an internal storage unit 204, an external storage apparatus 205, an operation unit 207, a display unit 208, a communication unit 209 and a HighSpeed USB host controller 210.

An external storing medium 206 is connected to the external storage apparatus 205.

In accordance with a program read from the ROM 202, the RAM 203 or the internal storage unit 204, or from the external storing medium 206 by the external storage apparatus 205, the CPU 201 controls the entire operation of the external processing apparatus 200 via a system bus.

The ROM 202 is used to store control programs for the CPU 201, and the RAM 203 is memory for temporarily storing programs and image data, and is used to perform fast processing for the external processing apparatus 200.

An operating system, various application programs and image data are stored in the internal storage unit 204. Also stored in the internal storage unit 204 are software, for example, for performing a character data processing step in the embodiment, application software for exchanging various control commands and data with the image processing apparatus 100, printer driver software, scanner drive software, facsimile driver software, USB class drive software for each function, and USB bus driver software.

Generally, the application software and the driver software are received and stored in the external storing medium 206, such as a floppy (trademark) disk or a CD-ROM medium, from other computer-readable media, and installed by controlling the external storage apparatus 205.

The application software and the driver software may be received by the communication unit 209, such as a network or a modem, via a communication line, and then may be installed in the internal storage unit 204.

The operation unit 207 controls a keyboard or a mouse (not shown), as instruction input means employed by an operator. Generally, at the start of printing, the keyboard or the mouse provided for the operating unit 207 is employed.

The display unit 208 displays various indications for the operator. When printing is started by the external processing apparatus 200, a confirmation dialogue, for example, is displayed on the display unit 208 to prompt the operator to enter data. During the printing operation, information representing a print state is presented for the operator.

The communication unit 209 is connected to a network (not shown) to establish a connection with an Internet provider via the communication line 221, or to exchange data or image information with another communication apparatus via the communication line 221. Since a well known method is employed for the connection to the network or to the communication line 221, an explanation for this will be omitted.

The HighSpeed USB host controller 210 controls communication of the USB interface. According to the USB communication standards, the HighSpeed USB host controller 210 converts into USB packets data received from the CPU 201, and transmits the USB packets to the image processing apparatus 100. Further, the HighSpeed USB host controller 210 converts into data USB packets received from the image processing apparatus 100 and transmits the data to the CPU 201. Since for controlling communication, a well known method is employed, no further explanation for it will be given.

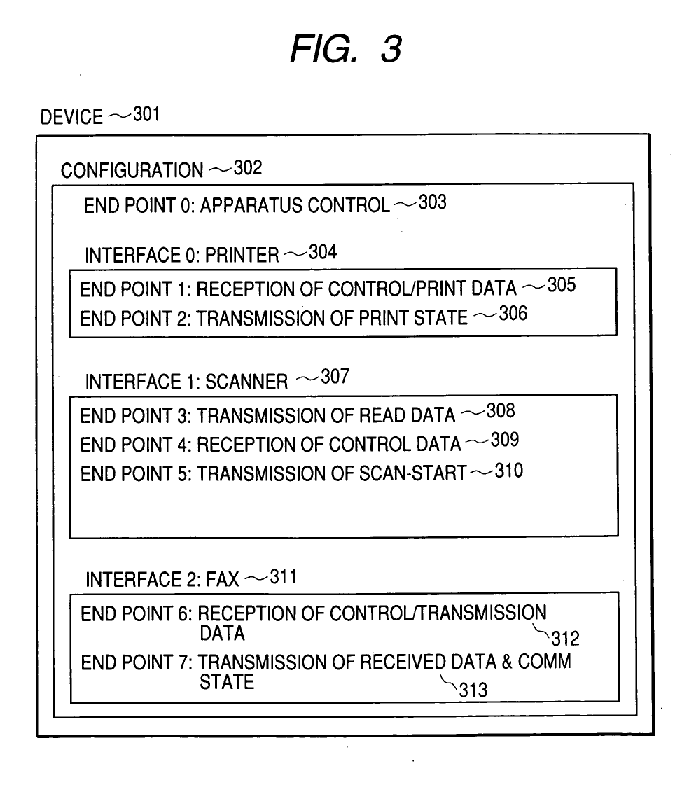

FIG. 3 is a conceptual diagram showing the configuration of the image processing apparatus 100 that conforms to the USB communication standards.

The HighSpeed USB function controller 113 controls the USB interface in accordance with the configuration shown in FIG. 3.

Only one device 301 can be defined in accordance with the USB communication standards, and can be shown as the largest frame, representing the attribute of the overall image processing apparatus 100. The attribute of the device 301 is expressed by a device descriptor, which includes an apparatus manufacturer ID, a product ID, a release number and the number of configurations. In this embodiment, the number of configurations is “1”.

Therefore, only one configuration (configuration 1 (302)) is defined in the device 301. The attribute of the configuration 1 (302) is expressed by the configuration descriptor, which includes the number of interfaces provided for the configuration. In this embodiment, the number of interfaces is “3”.

Thus, three interfaces (interfaces 0, 1 and 2 (304, 307 and 311)) are defined in the configuration 1 (302). The attributes of the interfaces 0 to 2 (304, 307 and 311) are expressed by interface descriptors, each of which includes the number of end points for a pertinent interface, the class code, etc.

In the embodiment, the number of end points in the interface 0 (304) employed for a printer is “2”; the number of end points in the interface 1 (307) employed for a scanner is “3”; and the number of end points in the interface 2 (311) employed for FAX transmission/reception is “2”.

Therefore, two end points (end points 1 and 2 (305 and 306)) are defined in the interface 0 (304) used for a printer. The attributes of the end points 1 and 2 (305 and 306) are defined by end point descriptors, each of which includes an end point number for a pertinent end point, a communication direction, a transfer type, a packet size, etc. The end point 1 (305) is mainly employed to receive control data and print data, and the end point 2 (306) is mainly employed to transmit the print state of the received print data.

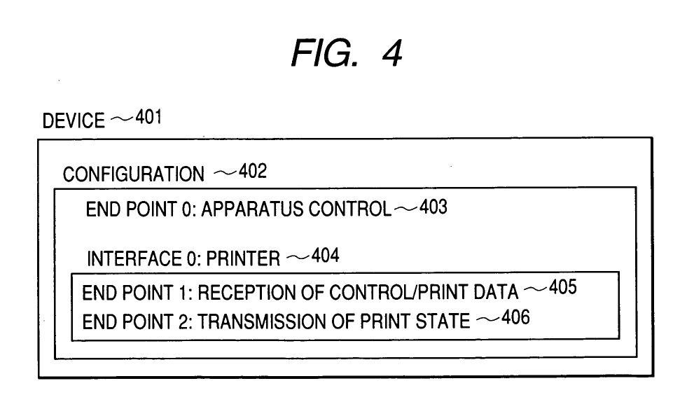

These two end points (305) and (306) can also be regarded as virtual visible end points 1 and 2 (405 and 406) for the recording unit 115 in FIG. 4, which will be described later. Although the use of the end point descriptor for the recording unit 115, which is obtained from the host controller 114, is desired, the descriptor obtained by the recording unit 115 can not be employed without change. Since, the packet size for the HighSpeed USB differs from the packet size for the FullSpeed USB, this difference is changed. When the end points are allocated for the interfaces following the interface 1, the end point numbers are also shifted, so that the end point numbers must also be overwritten in order to be used.

Further, only three end points (end points 3, 4 and 5 (308, 309 and 310)) are defined in the interface 1 (307) used for a scanner.

The attributes of the end points 3, 4 and 5 (308, 309 and 310) are described by end point descriptors, each of which includes an end point number for a pertinent end point, a communication direction, a transfer type, a packet size, etc. The end point 3 (308) is used mainly for the transmission of read data.

The end point 4 (309) is used mainly for the reception of control data, and the end point 5 (310) is used mainly for a notification that scanning has been activated.

Furthermore, only two end points (end points 6 and 7 (312 and 313)) are defined for the interface 2 (311) used for FAX transmission/reception. The attributes for the end points 6 and 7 (312 and 313) are described by end point descriptors, each of which includes the end point number of a pertinent end point, a communication direction, a transfer type, a packet size, etc. The end point 6 (312) is used mainly for the reception of control data and FAX transmission data, and the end point & (313) is used mainly for the transmission of FAX reception data and the communication state of the FAX transmission/reception.

FIG. 4 is a conceptual diagram showing the configuration of the recording unit 115, in the embodiment, that conforms to the USB communication standards.

According to the USB communication standards, only one device 401 can be defined as is indicated by the largest frame, and represents the attribute for the overall apparatus, which in this case is the recording unit 115. The attribute of the device 401 is described by a device descriptor that includes an apparatus manufacturer ID, a product ID, a release number, the number of configurations, etc. In this embodiment, the number of configurations is “1”.

Only one configuration (configuration 1 (402)) is defined for the device 401. The attribute of the configuration 1 (402) is described by a configuration descriptor that includes the number of interfaces in the configuration. In this embodiment, the number of interfaces is “1”.

Therefore, only one interface (interface 0 (404)) is defined in the configuration 1 (402). And the attribute of the interface 0 (404) is described by an interface descriptor that includes the number of the end points in the interface, a class code, etc. In this embodiment, the number of end points in the interface 0 (404) used for printing is “2”.

Thus, only two end points (end points 1 and 2 (405 and 406)) are defined in the interface 0 (404) used for printing. The attributes of the end points 1 and 2 (405 and 406) are described by end point descriptors, each of which includes the end point number of a pertinent end point, a communication direction, a transfer type, a packet size, etc. The end point 1 (405) is used mainly for the reception of control data and print data, and the end point 2 (406) is used mainly for the transmission of the print state of the received print data.

The operation of the image processing apparatus 100 will now be described.

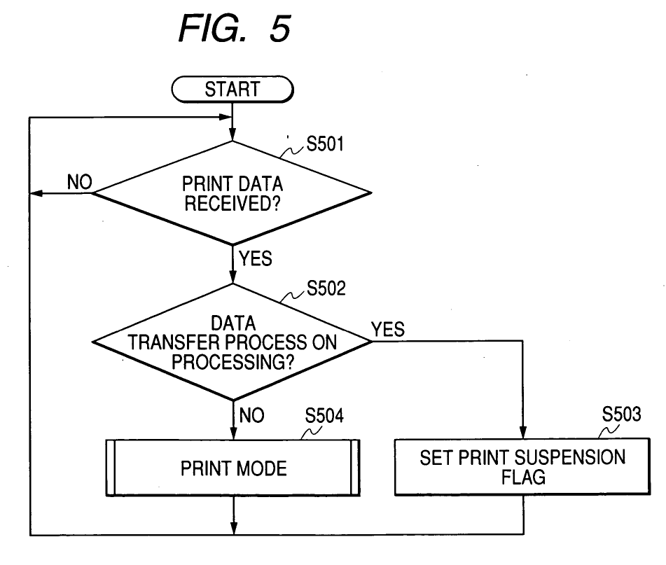

FIG. 5 is a flowchart showing the printing start operation performed by the CPU 101 of the image processing apparatus 100 in the embodiment.

First, at step S501, a check is performed to determine whether the image processing apparatus 100 has received print data from the external processing apparatus 200. When the image processing apparatus 100 has received print data, program control advances to step S502. When the image processing apparatus 100 has not received print data, the process at step S501 is repeated. For the reception of print data, a logical channel is employed that is used for controlling the end point 1 (305), in FIG. 3, and for receiving print data.

The print data is received in a packet form that is limited to a predetermined length. In the embodiment, since the HighSpeed USB host controller 210 transmits print data in the packet form, and the HighSpeed USB function controller 113 receives the print data in this packet form, both controllers 210 and 113 support HighSpeed USB, and thus, communication can be performed by using a packet size (512 bytes each) determined in accordance with the HighSpeed USB communication standards.

At step S502, if the image processing apparatus 100 is currently reading out data from the HighSpeed USB function controller 113 or so as to execute a read-in operation other than printing, facsimile transmission or the like, print data can not be read out at the same time from the HighSpeed USB function controller 113. Thus, program control is shifted to step S503 and a print suspension flag is set. Thereafter, program control returns to step S501.

At step S504, the operating mode is shifted to a print mode during which print data, received from the external processing apparatus 200, is printed by the image processing apparatus 100. The print mode will be described in detail later. And when the print mode is ended, program control is shifted to a waiting step again for waiting for print data from the external processing apparatus 200.

If, when a read-in instruction or facsimile data is received, the data transfer process is currently being performed, a read-in suspension flag or a facsimile suspension flag is set in the same way as in the printing process in FIG. 5. No further exp lanation for this process will be given.

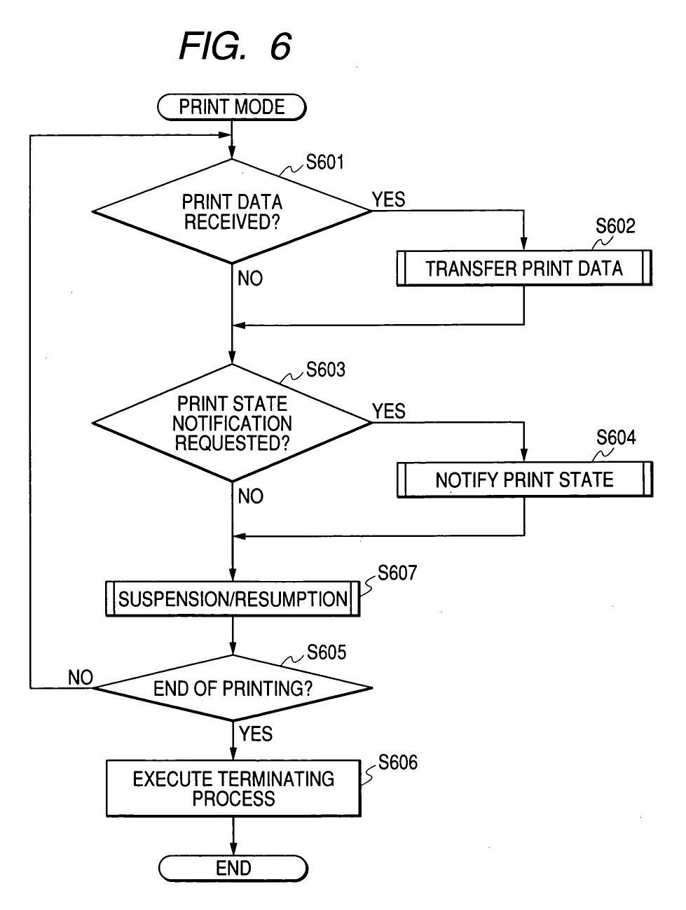

FIG. 6 is a flowchart showing the printing operation performed by the CPU 101 of the image processing apparatus 100 in the print mode at step S504 in FIG. 5.

First, at step S601, a check is performed to determine whether the image processing apparatus 100 has received print data from the external processing apparatus 200. When print data has been received, program control advances to step S602, or when the print data has not yet been received, program control is shifted to step S603. For the reception of print data, a logical channel is employed that is used for controlling the end point 1 (305) in FIG. 3 and for receiving print data. The received print data is temporarily stored in the USB memory 116.

At step S602, the print data, which the image processing apparatus 100 has received from the external processing apparatus 200 and stored in the USB memory 116, is transmitted to the recording unit 115. The transmission of the print data will be described in detail later. When the process at step S602 is completed, program control advances to step S603.

At step S603, a check is performed to determine whether the image processing apparatus 100 has received a notification request for a print state from the external processing apparatus 200. When a notification request has been received, program control advances to step S604, or when a notification request has not been received, program control is shifted to step S605. For the reception of the notification request for the print state, a logical channel used for print state transmission in the end point 2 (306) in FIG. 3 is employed. It should be noted that for the reception of the notification request for the print state, actual data is not received, but instead, an IN packet is received that conforms to the USB communication standards.

At step S604, in the image processing apparatus 100, data indicating the print state is obtained from the recording unit 115 and is transmitted to the external processing apparatus 200. The transmission of data indicating the print state will be described in detail later.

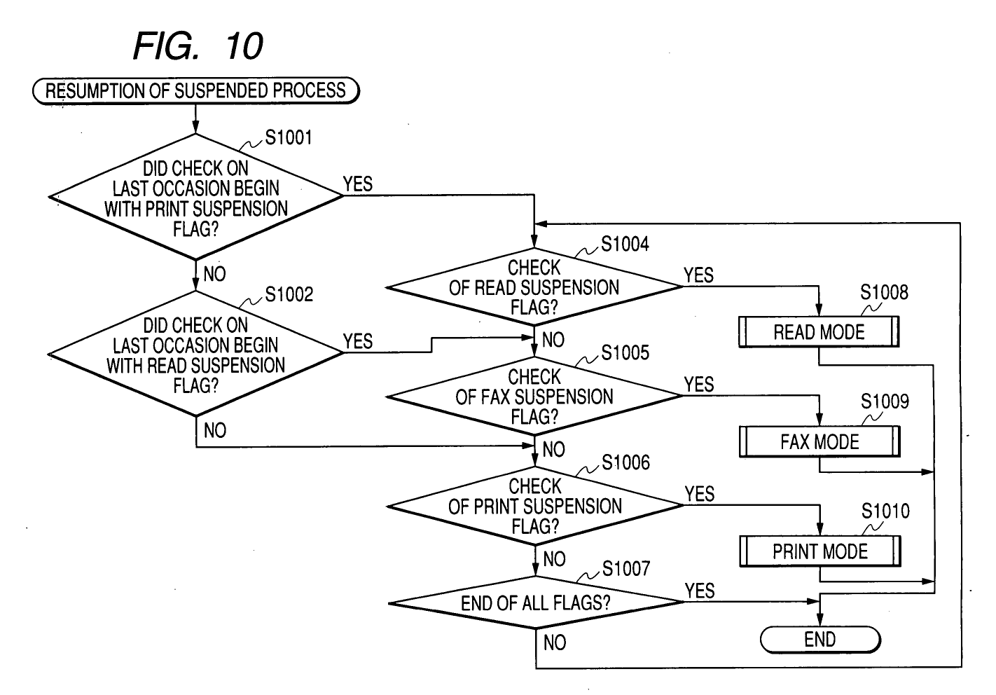

In case of the printing process, when the reading-out of data from the HighSpeed USB function controller 113 has temporarily been ended. S607, if there is any other suspended data reading-out, the suspension resuming process shown in FIG. 10, which will be described later, must be performed in order to resume the suspended data reading-out. Similarly, in case of the facsimile communication process or the data reading-in process, which is performed in the same manner as in the printing process and thus will not be described, when the reading-out of data from the HighSpeed USB function controller 113 has been temporarily ended, the suspension resuming process at S607, which will be described later referring to FIG. 10, must be performed.

At step S605, a check is performed to determine whether print data received from the external processing apparatus 200 has been printed. When the print data has been processed, program control advances to step S606. But when the print data has not yet been printed, program control returns to step S601. Since a well known method (described, for example, in patent document 1) is employed to detect whether the printing of print data received from the external processing apparatus 200 has been completed, no further explanation for it will be given.

At step S606, the process for terminating the printing operation is performed. As for the process for terminating the printing process, printing material is discharged, outside the mechanism, a printing end sound is emitted by loudspeakers (not shown), and/or an indication representing the end of the printing operation is displayed by the operation/display unit 108 or the display unit 208.

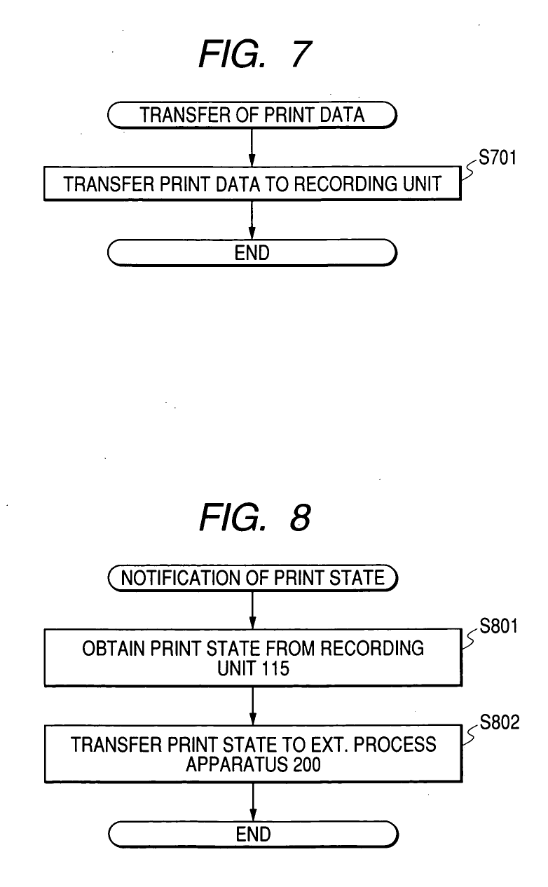

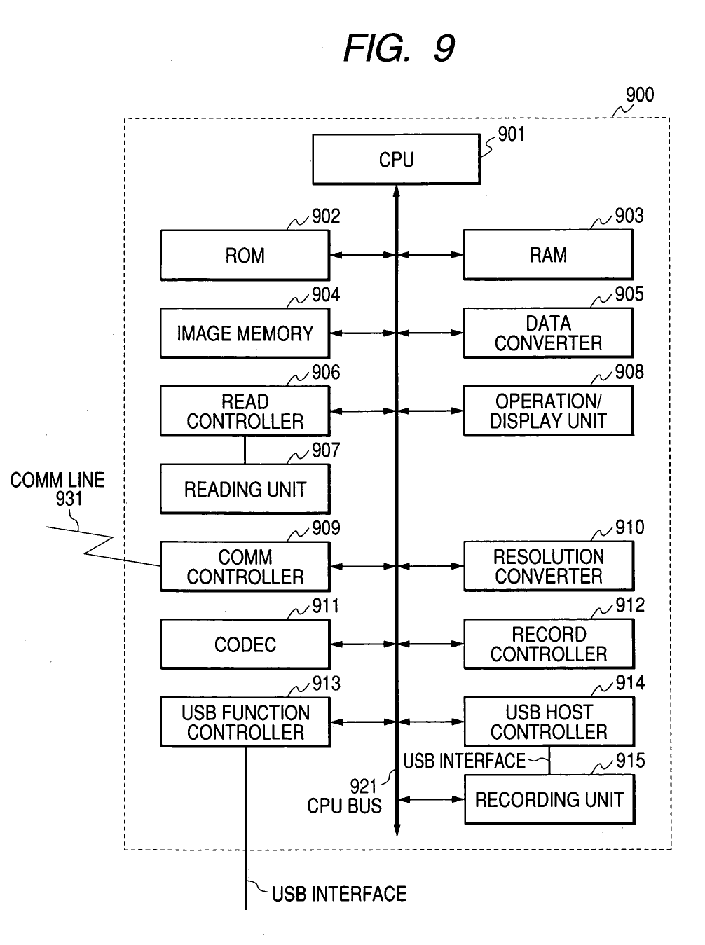

FIG. 7 is a flowchart showing the print data transfer process at step S602 in FIG. 6.

At step S701, the print data received at step S601 is transferred to the recording unit 115. The CPU 101 receives, via a logical channel used for controlling the end point 1 (305) in FIG. 3.and for receiving print data, data in a packet having a size (a minimum 512 bytes) that is defined in accordance with the HighSpeed USB communication standards, and temporarily stores the data in the USB memory 116. Thereafter, the CPU 101 transmits the stored data to a logical channel used for controlling the end point-1 (405) in FIG. 4 and for receiving print data.

At this time, since the FullSpeed USB host controller 114 transmits data, and the recording unit 115, which is compatible with FullSpeed USB, receives data, the two units 114 and 115 do not support HighSpeed USB, so that communication is performed by employing a packet size (a maximum 64 bytes) that is defined in accordance with the FullSpeed USB communication standards.

As is described above, when the USB memory 116 is employed, a packet received from the external processing apparatus 200 using HighSpeed USB can be transmitted to the recording unit 115 by using FullSpeed USB.

FIG. 8 is a flowchart showing the print state notification operation at step S604 in FIG. 6.

At step S801, the CPU 101 controls the FullSpeed USB host controller 114 and obtains, from the recording unit 115, data indicating the print state. For the acquisition of data indicating the print state, a logical channel is employed that is used for transmitting the print state for the end point 2 (406) shown in FIG. 4. The obtained data, which indicates the print state, is temporarily stored in the USB memory 116. It should be noted that the obtained data indicating the print state is in a packet form that is limited to a predetermined length.

At step S802, the CPU 101 transmits to a logical channel, used for transmitting the print state for the end point 2 (306) in FIG. 3, the data that is temporarily stored in the USB memory 116 and that indicates the print state.

At this time, the CPU 101 detects the printing end by analyzing part of the data that is stored in the USB memory 116 and that indicates the print state, and employs the detection results to determine, at step S605 in FIG. 6, whether the printing has been terminated.

When data indicating the print state can not be obtained from the recording unit 115 for some reasons such as the recording unit 115 being warming up, the CPU 101 transmits a pseudo response to the logical channel used for transmitting the print state for the end point 2 (306) in FIG. 3.

FIG. 10 is a flowchart showing the suspension resuming operation at step S607 in FIG. 6.

The operation in FIG. 10 is performed after the reading process performed by the HighSpeed USB function controller 113 has been temporarily halted, and during this operation, the CPU 101 resumes the suspended data transfer.

First, at steps S1001 and S1002, a check is performed to determine what suspension flag the examination in the previous suspension resuming process (the previous examination) begun with. When the previous examination begun with the print suspension flag, the examination in the current suspension resuming process (the current examination) begins with a read-in suspension flag at step S1004. When the previous examination begun with the read-in suspension flag, at S1005, the current examination begins with the facsimile suspension flag. In other cases, i.e., when the previous examination begun with the facsimile suspension flag, or when the current examination is the first time, it begins with the print suspension flag.

As is described above, when a suspension flag to be examined is changed each time, the suspended operation can be resumed evenly, and efficient scheduling can be obtained.

At step S1004, the read-in suspension flag is examined. When the read-in suspension flag has been set, program control is shifted to step S1008 and the processing in the read-in mode is resumed. Since this process is performed in the same manner as the printing process, no detailed explanation for it will be given.

At step S1005, the facsimile suspension flag is examined. When the facsimile suspension flag has been set, program control is shifted to step S1009, and the process in the facsimile mode is resumed. Since this process is performed in the same manner as the printing process, no detailed explanation for it will be given. At step S1006, the print suspension flag is examined. When the print suspension flag has been set, program control is shifted to step S1010 and the process in the print mode is resumed.

At step S1007, a check is performed to determine whether all the flags have been examined. When all the flags have been examined, the suspension resuming process is terminated.

As is described above, when the reading-out of data from the HighSpeed USB function controller 113 is heated in the printing process, if there is any other suspended data reading-out at step S607, the suspension resuming process in FIG. 10 is performed to resume the reading-out of the data. In the facsimile communication process or the reading process, when reading of data from the HighSpeed USB function controller 113 is temporarily halted, the suspension resuming process in FIG. 10 must be performed at step S607. Since this process is performed in the same manner as in the printing process, no detailed explanation for it will be given.

At this time, the CPU 101 detects the end of printing by analyzing part of the data that is stored in the USB memory 116 and that indicates the print state, and employs the detection results to determine, at step S605 in FIG. 6, whether the printing has been completed.

When data indicating the print state can not be obtained from the recording unit 115 for some reasons such as the recording unit 115 being warming up, the CPU 101 transmits a pseudo response to a logical channel used for the transmission of the print state for the end point 2 (306) in FIG. 3.

In the embodiment, the HighSpeed USB function controller 113 is an example of the first bus connection means, while the FullSpeed USB host controller 114 is an example of the second bus connection means, and the communication speed differs between the first bus connection means and the second bus connection means. Furthermore, the HighSpeed USB function controller 113 and the FullSpeed USB host controller 114 are examples of the first bus connecting portion and the second bus connecting portion for performing bi-directional data transmission.

The CPU 101 and the ROM 102 together constitute an example for the controller for controlling the first bus connecting portion, the second bus connecting portion and the memory to adjust the speed difference between the first bus and the second bus, and for permitting the exchange of data by the host and the data processor via the first bus connecting portion and the second bus connecting portion.

Further, the CPU 101 and the ROM 102 together constitute an example for a controller that changes the packet size of the data when the host and the data processor exchange the data via the first bus connecting portion and the second bus connecting portion.

In addition, the CPU 101 and the ROM 2 together constitute an example for storage control means for temporarily storing, in storage means, data OUT and data IN.

Moreover, the CPU 101 and the ROM 102 together constitute an example for the controller for writing, in the memory, the state of the data processor obtained through the second bus, for transferring the state to the host via the first bus, or for transmitting a pseudo response to the host when the state of the data processor can not be obtained.

According to the embodiment, in an image processing apparatus that has a plurality of functions, such as a printer function, a scanner function and a facsimile communication function, wherein the first bus connecting portion is compatible with HighSpeed USB and the second bus connecting portion is compatible with FullSpeed USB, HighSpeed USB communication can be performed with a data processing terminal, such as a personal computer.

Furthermore, according to the embodiment, costs can be reduced, compared with when the first bus connecting portion and the second bus connecting portion are compatible with HighSpeed USB.

Further, according to the embodiment, since the scanner function and the facsimile communication function do not employ the second bus connecting portion, fast communication can be performed by using HighSpeed USB.

In addition, a printer or the like that uses the second bus connecting portion employs the USB memory 116 or the scheduling method realized by performing the suspension process in FIG. 5 or the suspension resuming process in FIG. 10, whereby the speed difference between the first bus connecting portion and the second bus connecting portion is absorbed, and the exchange of data with a data processing terminal, such as a personal computer, can be performed.

Further, when HighSpeed USB is employed for the second bus connecting portion, both a HighSpeed compatible device and a FullSpeed compatible device can be mixed via the second bus connecting portion by employing the USB memory 116 or the scheduling method.

The USB memory 116 is an example temporary storage means for absorbing the difference in speed between the first bus connecting portion and the second bus connecting portion.

The reading unit 107, the read controller 106 and the communication controller 109 are other examples of the data processor for exchanging data with the host via the first bus connecting portion, without going through the second bus connecting portion.

According to the embodiment, for an image processing apparatus that has a plurality of functions, such as a printer function, a scanner function and a facsimile communication function, and that employs a fast first bus connecting portion and a slow second bus connecting portion, data can be exchanged at a high speed with a data processing terminal, such as a personal computer. Therefore, the increase of a scanner speed can be expected without the second bus connecting portion being required. Further, by employing the above two methods, a printer or the like that employs the second bus connecting portion can absorb the speed difference between the first bus connecting portion and the second bus connecting portion, and can exchange data with a data processing terminal, such as a personal computer.

Further, in this embodiment, provided is an example method, for controlling the image processing apparatus that includes the first bus connecting portion which is connected to a host, the second bus connecting portion which is connected to a data processor and of which a communication speed is different from that of the first bus connecting portion, and a memory, for adjusting the speed difference between the first bus and the second bus, comprising the steps of:
controlling the first bus connecting portion, the second bus connecting portion and the memory to adjust the speed difference between the first bus and the second bus; and
permitting the host and the data processor to exchange data via the first bus connecting portion and the second bus connecting portion.

Further, in this embodiment, provided is an example program, for controlling the image processing apparatus that includes the first bus connecting portion which is connected to a host, the second bus connecting portion which is connected to a data processor and of which a communication speed is different from that of the first bus connecting portion, and a memory for adjusting the speed difference between the first bus and the second bus, that permits a data processing apparatus to perform the steps of:
controlling the first bus connecting portion, the second bus connecting portion and the memory to adjust the speed difference between the first bus and the second bus; and
permitting the host and the data processor to exchange data via the first bus connecting portion and the second bus connecting portion.

According to the effects obtained by the present invention, for an image processing apparatus that has a plurality of functions, such as a printer function, a scanner function and a facsimile function, wherein the first bus connecting portion is compatible with HighSpeed USB and the second bus connecting portion is compatible with FullSpeed USB, HighSpeed USB communication can be performed with a data processing apparatus, such as a personal computer.

This application claims priority from Japanese Patent Application No. 2003-332508 filed on Sep. 24, 2003, which is hereby incorporated by reference herein.

1. An image processing apparatus comprising:
a first bus connecting portion which is connected to a host apparatus;
a second bus connecting portion which is connected to a data processing portion and of which a communication speed is different from that of the first bus connecting portion;
a memory portion for adjusting a speed difference between a first bus and a second bus; and
a controller for controlling the first bus connecting portion, the second bus connecting portion and the memory portion to adjust the speed difference between the first bus and the second bus, and for permitting the host apparatus and the data processing portion to exchange data via the first bus connecting portion and the second bus connecting portion.

2. An image processing apparatus according to claim 1, wherein the controller changes a packet size for the data when the host apparatus and the data processing portion exchange the data via the first bus connecting portion and the second bus connecting portion.

3. An image processing apparatus according to claim 1, wherein the controller writes, in the memory portion, the state of the data processing portion, obtained via the second bus, and transmits the state to the host apparatus via the first bus, or transmits a pseudo response to the host apparatus when the state of the data processing portion is not obtained.

4. An image processing apparatus according to claim 1, wherein the first bus connecting portion is compatible with a high speed according to the universal serial bus (USB) communication standards, and the second bus connecting portion is compatible with a full speed according to the USB communication standards.

5. An image processing apparatus according to claim 1, further comprising:
a different data processing portion for exchanging data with the host apparatus via the first bus connecting portion, not via the second bus connecting portion.

6. An image processing apparatus according to claim 5, wherein the data processing portion is a printer, and the different data processing portion is, at the least, either a reading unit for reading a document, or a facsimile communication unit.

7. A control method, for an image processing apparatus that includes a -first bus connecting portion which is connected to a host apparatus, a second bus connecting portion which is connected to a data processing portion and of which a communication speed is different from that of the first bus connecting portion, and a memory portion for adjusting a speed difference between a first bus and a second bus, said method comprising:
a control step of controlling the first bus connecting portion, the second bus connecting portion and the memory portion to adjust the speed difference between the first bus and the second bus, and permitting the host apparatus and the data processing portion to exchange data via the first bus connecting portion and the second bus connecting portion.

8. A control method according to claim 7, wherein, at the control step, a packet size is changed for the data when the host apparatus and the data processing portion exchange the data via the first bus connecting portion and the second bus connecting portion.

9. A control method according to claim 7, wherein, at the control step, the state of the data processing portion, obtained via the second bus is written in the memory portion, and is transmitted to the host apparatus via the first bus, or a pseudo response is transmitted to the host apparatus when the state of the data processing portion is not obtained.

10. A control method according to claim 7, wherein the first bus connecting portion is compatible with a high speed according to the universal serial bus (USB) communication standards, and the second bus connecting portion is compatible with a full speed according to the USB communication standards.

11. A control method according to claim 7, wherein the image processing apparatus further includes:
a different data processing portion for exchanging data with the host apparatus via the first bus connecting portion, not via the second bus connecting portion.

12. A control method according to claim 11, wherein the data processing portion is a printer, and the different data processing portion is, at the least, either a reading unit for reading a document, or a facsimile communication unit.

13. A control program, for an image processing apparatus including a first bus connecting portion which is connected to a host apparatus, a second bus connecting portion which is connected to a data processing portion and of which a communication speed is different from that of the first bus connecting portion, and a memory portion for adjusting a speed difference between a first bus and a second bus, said control program being executable by an information processing apparatus, said control program comprising:
a control step of controlling the first bus connecting portion, the second bus connecting portion and the memory portion to adjust the speed difference between the first bus and the second bus, and permitting the host apparatus and the data processing portion to exchange data via the first bus connecting portion and the second bus connecting portion.

14. A control program according to claim 13, wherein said control step changes a packet size for the data when the host apparatus and the data processing portion exchange the data via the first bus connecting portion and the second bus connecting portion.

15. A control program according to claim 13, wherein said control step write, in the memory portion, the state of the data processing portion, obtained via the second bus, and transmitting the state to the host apparatus via the first bus, or transmitting a pseudo response to the host apparatus when the state of the data processing portion is not obtained.

16. A control program according to claim 13, wherein the first bus connecting portion is compatible with a high speed according to the universal serial bus (USB) communication standards, and the second bus connecting portion is compatible with a full speed according to the USB communication standards.

17. A control program according to claim 13, wherein the image processing apparatus further includes:
a different data processing portion for exchanging data with the host apparatus via the first bus connecting portion, not via the second bus connecting portion.

18. A control program according to claim 17, wherein the data processing portion is a printer, and the different data processing portion is, at the least, either a reading unit for reading a document, or a facsimile communication unit.
